(19) United States
(12) Patent Application Publication
(10) Pub. No.: US 2026/0247824 A1
(43) Pub. Date: Aug. 20, 2026

(54) DIFFERENT SPACE-LINKED METAVERSE PLATFORM SYSTEM

(71) Applicant: Sungwoon KANG, Busan (KR)

(72) Inventor: Sungwoon KANG, Busan (KR)

(21) Appl. No.: 19/644,283

(22) Filed: Apr. 10, 2026

Related U.S. Application Data
(63) Continuation of application No. 18/835,119, filed on Feb. 5, 2023.

(30) Foreign Application Priority Data
Feb. 8, 2022 (KR) 10-2022-0016546

(51) Int. Cl. H10K 59/131; G06Q 30/0601; G06Q 50/163; G06T 19/20

(52) U.S. Cl. CPC H10K 59/1315; G06Q 30/0619; G06Q 50/163; G06T 19/20

(57) ABSTRACT

The present invention relates to a different space linked metaverse platform wherein, upon determining that an optimum means of increasing a real estate intrinsic value is activating air rights transactions of which active exercises of rights have been practically abandoned among private property, an explicit link with actual assets is presented as a means of overcoming a limit of virtual assets, the limit being incurred due to lack of links with the actual assets, and as a specific means, an air rights transaction market place is installed inside the metaverse platform and intrinsic values of real estate and virtual property are all enhanced through a reciprocal link sharing the virtual assets used in the metaverse platform as a payment means.

### CROSS-REFERENCE TO RELATED APPLICATOINS

This Application claims the benefit of, and is a continuation of, U.S. Non provisional patent application Ser. No.18/835, 119, filed on August 01, 2024, which is a U.S. National Phase Application of PCT International Application Number PCT/KR2023/001626, filed on Feb. 05, 2023, designating the United States of America and published in the Korean language, which is an International Application of and claims the benefit of priority to Korean Patent Application No. 10-2022-0016546, filed on Feb. 08, 2022. All of the foregoing applications are hereby incorporated by reference as if fully set forth herein in their entirety.

### TECHNICAL FIELD

The present invention relates to a different space linked metaverse platform wherein, upon determining that an optimum means of increasing a real estate intrinsic value is activating air rights transactions of which active exercises of rights have been practically abandoned among private property, an explicit link with actual assets is presented as a means of overcoming a limit of virtual assets, the limit being incurred due to lack of links with the actual assets, and as a specific means, an air rights transaction market place is installed inside the metaverse platform and intrinsic values of real estate and virtual property are all enhanced through a reciprocal link sharing the virtual assets used in the metaverse platform as a payment means.

### BACKGROUND ART

Despite the surge in asset value due to the global pandemic, the social volatility cannot be ignored due to the intrinsic value of real estate that cannot catch up the surge of the market value and there is a need to enhance the intrinsic value of real estate overall as a buffer against excessive volatility as the gap between the market value and intrinsic value of real estate widens, but there is no appropriate means to do so.

In addition, since virtual assets called cryptocurrencies carry high risks due to the lack of clear link with real assets, to enhance the intrinsic value of virtual assets, it is necessary to demonstrate their stability and utility as a means of payment in the market through consistently linked operation with real assets.

In addition, because the air rights above the land where the owner exists are tangible assets only in the space where the owner's legitimate rights are exercised although the air rights are intangible assets, and the lack of an activated intermediary market is a stumbling block to activating air rights transaction although the air rights are the optimal means to enhance the intrinsic value of real estate without additional cost, a link of air rights transaction and virtual asset is required through the sharing of means of payment within the same platform based on mutual consistency between the air rights and an intermediary market

### DISCLOSURE

### Technical Problem

The present invention is made in order to improve the limitations of the existing technology as described above, and focuses on activating the air rights transaction as the optimal means for increasing the intrinsic value of real estate. With the advanced mobility technology, the transition from existing two-dimensional plane movement to three-dimensional spatial movement is a well-established fact, so the value of air rights that a significant number of urban air mobility must pass through will soon be reconsidered.

Thus, as a means of activating air rights transactions of which active exercises of rights have been practically abandoned among private property and overcoming a limit of virtual assets due to lack of links with the actual assets, providing of different space linked metaverse platform system is a purpose of the present invention that is a reciprocal technique installing an air rights transaction market place inside the metaverse platform to secure physical link with actual assets and sharing the virtual assets used in the metaverse platform as a payment means.

### Technical Solution

The different space linked metaverse platform system related to the present invention for achieving the above-mentioned purposes and solving the problems of conventional technologies comprises a metaverse platform administrator managing the metaverse platform, a metaverse platform app development supporter supporting app developers who develop application programs (App) installed on the metaverse platform, a development support tool to encourage and support development by app developers, app developers developing and managing apps for profit, members (physical entity), and a metaverse platform accommodating the metaverse ecosystem.

The metaverse platform forming one aspect of the present invention comprises air rights transaction marketplace installed as a means to strengthen the link between physical assets for the purpose of enhancement of the intrinsic value of offline real estate, a metaverse marketplace which is an essential element for activating the metaverse ecosystem, a three-dimensional spherical metaverse planet which serves as a fundamental basis for creating the metaverse ecosystem, apps developed by app developers and installed on the metaverse platform, and avatars which are representative means projecting the intentions and desires of members into the metaverse ecosystem beyond physical space.

### Advantageous Effects

According to the present invention, the present invention is presented to improve the conventional technology like the above, and by allowing transactions in which virtual assets are shared as a payment method for air right transaction within the metaverse platform when the marketplace for air rights transaction is provided, it is possible to provide a technical means for the organic link of different space and reciprocal formation through the self-generative network effect occurring in the metaverse ecosystem.

Furthermore, as a means to achieve the above-mentioned purpose, at least one three-dimensional spherical shape of a metaverse planet must be formed within the metaverse platform provided by the present invention, the virtual universe within the metaverse platform expands through additional creation of metaverse planets as needed, and as all three-dimensional spatial shapes can be completely filled without gaps by a cube, if the interior and exterior of the three-dimensional sphere are filled by stacking a designated size of unit cubes in an orderly manner along each coordinate axis direction from the center point of the metaverse planet in the metaverse platform, it becomes a technical basis for precisely determining the exact position of each unit cube. Thus, by assigning unique address information (code) to each unit cube based on specific rules, it becomes possible to accurately identify the location information of all metaverse planets and spaces generated within the metaverse platform.

Additionally, as a means to achieve the above-mentioned objectives, if we assume that the center coordinates of the initially created metaverse planet upon the activation of the metaverse platform as (0,0,0), because this coordinate serves as a singularity point which marks the genesis of the virtual universe created within the metaverse platform, the metaverse planet becomes the center of the virtual universe generated within the metaverse platform as a standard star. Based on this singularity point, because it is feasible to specify any coordinates in the virtual universe created within the metaverse platform, teleportation of specific objects is possible to any location within the metaverse platform without any physical constraints. Because that corresponds with the theory of universe creation through the primordial singularity presented as the basis for physical space generation, based on the rationale of applying technical idea conforming to natural laws, it is possible to offer infinite scalability and potential as a property to the members.

Furthermore, as a means to achieve the above-mentioned objectives, according to the present invention, because the air rights and subsurface rights existing inside and outside based on the surface of the metaverse planet created through the stacking of unit cubes occur due to scarcity on the basis of the setting of a virtual upper limit and the exchange value of the air rights and subsurface rights are increased by shortages or surpluses, this technical means is clearly distinguished from other technologies. Therefore, the metaverse platform provided by the present invention allows for setting of height limitation and depth limitation for individual metaverse planets, and by the function of upper limit setting in metaverse planets present within the metaverse platform, differentiated norm regarding land ownership in virtual space can be provided which is impossible with existing technologies.

### DESCRIPTION OF DRAWINGS

FIG. 1 illustrates three-dimensional rights that extends a property rights of the land above and below the earth’s surface related to the present invention.

FIG. 2 illustrates a conceptual diagram of a different space linked metaverse platform system according to the present invention.

FIG. 3 shows a process for generating a new metaverse planet according to the present invention.

FIG. 4 shows a concept of space configuration method based on a unit cube that forms a scale for generating a new metaverse planet and a singularity that forms the starting point of the virtual universe.

FIG. 5 is an example to show that the possibility of infinite expansion by the singularity of the present invention is based on the legitimacy of the technical idea in accordance with the natural law.

### BEST MODE FOR INVENTION

Hereinafter, the present invention will be described in more detail by the following examples. However, the following examples are for illustrative purposes only and are not intended to limit the scope of the present invention. The same reference numerals in each drawing indicate the same parts.

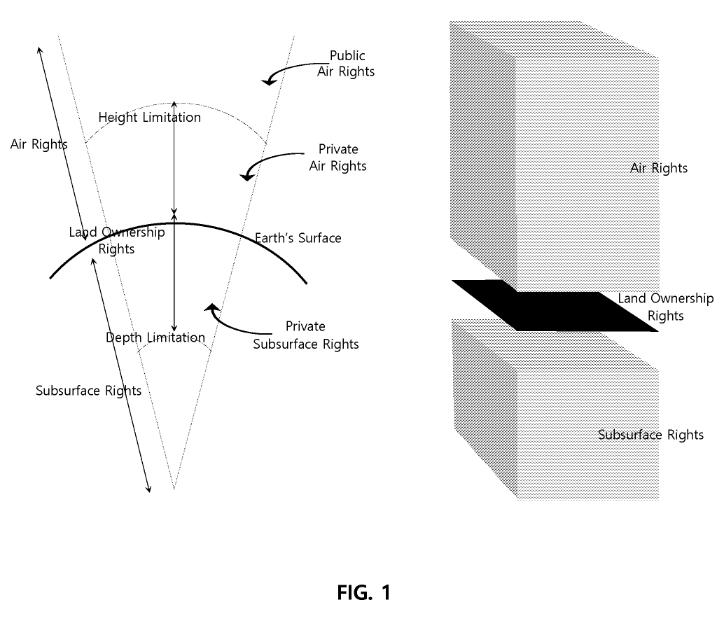

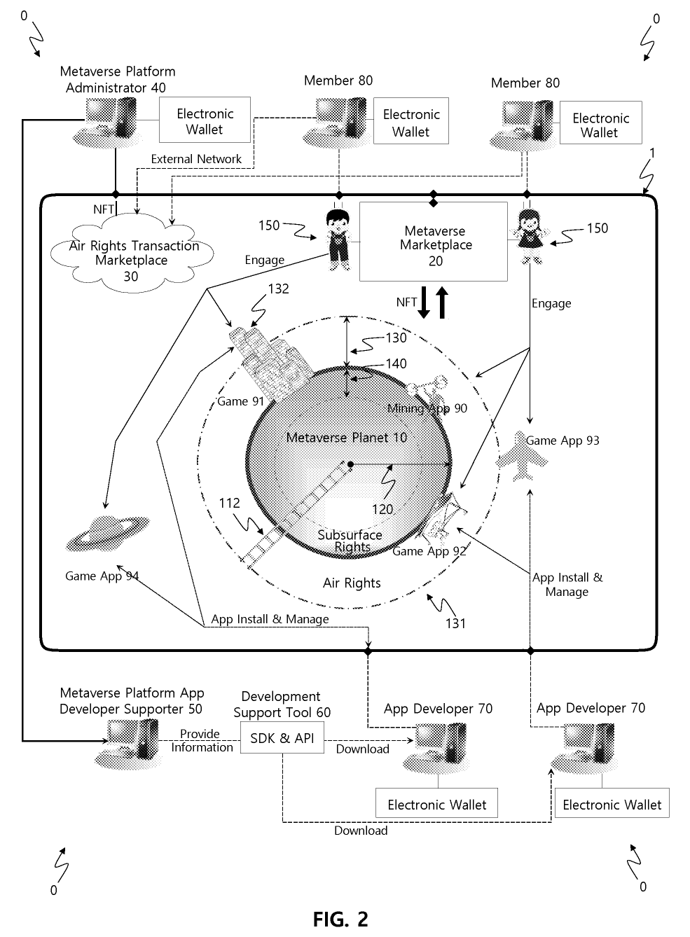

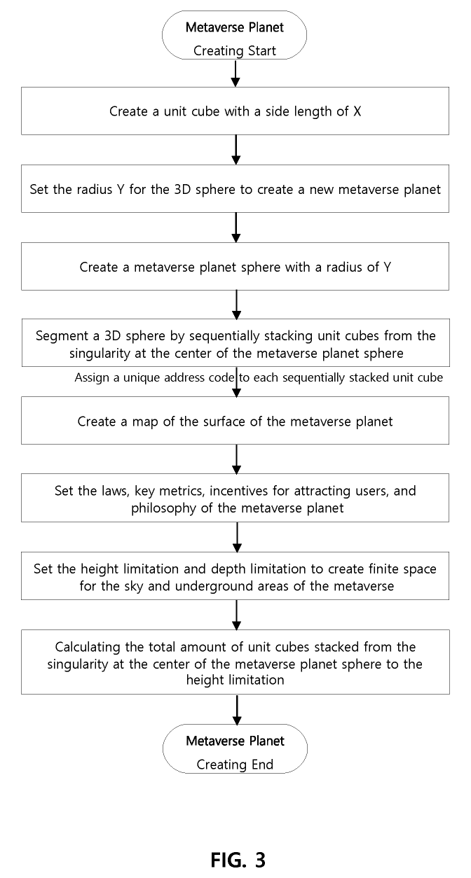

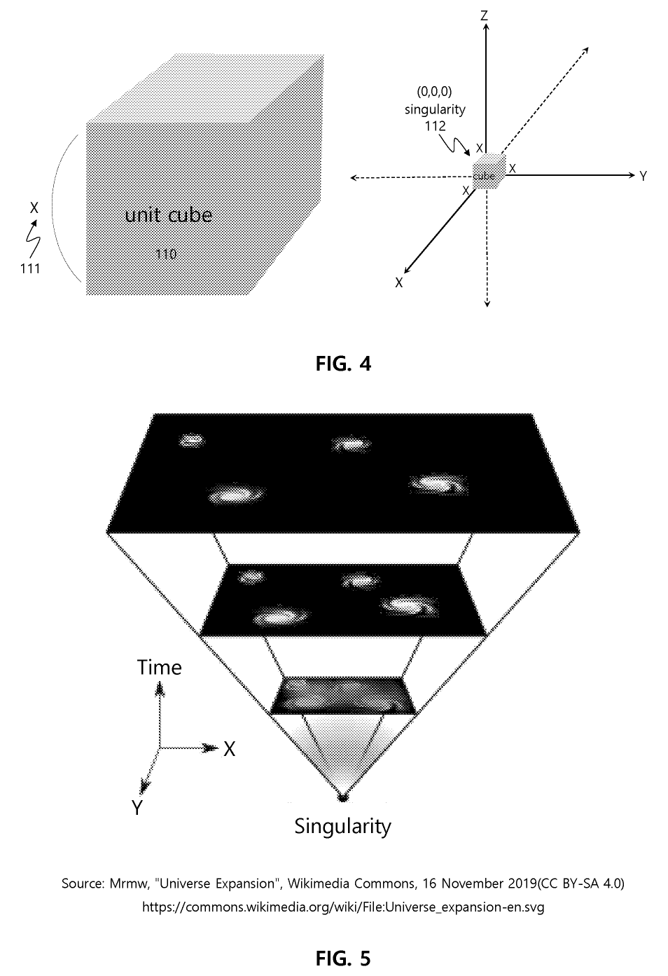

FIG. 1 illustrates the three-dimensional rights that extends a property right of the land above and below the earth’s surface related to the present invention, FIG. 2 illustrates a conceptual diagram of the different space linked metaverse platform system according to the present invention, FIG. 3 shows the process for generating a new metaverse planet according to the present invention, FIG. 4 illustrates the concept of space configuration method based on a unit cube that forms a scale for generating a new metaverse planet and a singularity that forms the starting point of the virtual universe, and FIG. 5 is an example to show that the possibility of infinite expansion by the singularity of the present invention is based on the legitimacy of the technical idea in accordance with the natural law.

As shown in FIG. 1, ownership rights regarding land where the owner exists are generated by the ownership divided into air rights and subsurface rights those are above and below the earth’s surface, are set limitation by regulation or recognized for the space where the exercise of the landowner's legitimate rights is deemed possible.

As shown in FIG. 2, the different space linked metaverse platform system according to the present invention comprises a metaverse platform administrator (40) managing the metaverse platform (1), a metaverse platform app developer supporter (50) supporting developers of app installed on the metaverse platform (1), development support tool (60) which is software to encourage and support app developers, app developers (70) developing and managing apps for profit, members (80), and a metaverse platform (1) accommodating the metaverse ecosystem.

The metaverse platform (1), which forms one aspect of the present invention, aims to enhance the intrinsic value of offline real estate, and comprises the air rights transaction marketplace (30) installed as a means for strengthening the link between virtual and real assets, the metaverse marketplace (20) which is an essential element for activating the metaverse ecosystem, the three-dimensional spherical metaverse planet (10) which serves as a fundamental basis for creating the metaverse ecosystem, the apps (91~94) developed by app developers (70) and installed on the metaverse platform (1), and avatars (150) which are representative means projecting the intentions and desires of members (80) into the metaverse ecosystem.

Also, the air rights transaction marketplace (30) that forms one aspect of the metaverse platform (1) is installed within the metaverse platform (1) for addressing the lack of intrinsic value of virtual assets caused by issuance of virtual assets without clear link to real assets, and enabling transaction of the air rights where exchange value of the air rights is created due to shortages or surpluses by setting a virtual limitation in the real space.

Furthermore, the metaverse marketplace (20), which forms one aspect of the metaverse platform (1), enables transaction of all goods consumed in the metaverse planet (10), and once a contract is concluded at the desired selling price, the agreed virtual assets are deducted from the buyer's electronic wallet and transferred to the seller's electronic wallet.

The app developer (70) present in the real space (0) outside the metaverse platform (1) forming another aspect of the present invention, installs and manages apps after designing various apps that can be installed on the metaverse platform (1), and create an environment and factors that enables the avatar (150) to build buildings, drive airplanes or yachts, or engage in shopping in a three-dimensional space consisting of land (91), sea (92), sky (93), and space (94) of the metaverse planet (10) after connecting to the metaverse platform (1) via a network.

Also, if the avatar (150) of a member (80) that constitutes one aspect of the real space (0) is unable to continue construction of a high-rise building (132) due to reaching the height limitation (130), further construction activities at the upper part of the high-rise building (132) are enabled by specifying an intention to purchase to a land owner who hopes to raise funds through the sale of remaining air rights in the metaverse marketplace (20) or purchasing the listed air rights for sale. In this way, even within the metaverse platform (1), through ensuring the air rights and subsurface rights of landowners by setting virtual limitations (131), the intrinsic value of the land acquired by the avatar (150) is increased, and through sanctioning with united power of members (80) or preventing in advance by property means competitive proliferation of high-rise buildings in specific areas or one-sided acts that violates other member’s (80) view rights, balanced growth in the metaverse ecosystem is induced.

### MODE FOR INVENTION

In FIG. 3, the process of creating a metaverse planet (10) that forms one aspect of the metaverse platform (1) is shown. Since all three-dimensional shapes in space can be filled with cubes, stacking (113) unit cube (110) with designated length (111) in each coordinate axis direction around the center point of the metaverse planet (10) successively without gaps serves as a technical basis for precisely determining the exact positions of each cube (110). Therefore, by assigning unique address information to each cube (110) according to certain rules, the precise location information of all metaverse planets and spaces created within the metaverse platform (1) can be accurately identified.

As shown in FIG. 4, if we assume that the center coordinates of the initially created metaverse planet upon the activation of the metaverse platform as (0,0,0), because this coordinate serves as a singularity point which marks the genesis of the virtual universe created within the metaverse platform, the metaverse planet becomes the center of the virtual universe as a standard star. Based on this singularity point, because it is feasible to specify any coordinates in the virtual universe created within the metaverse platform, teleportation of specific objects is possible to any location within the metaverse platform without any physical constraints.

As shown in FIG. 5, because that corresponds with the theory of universe creation through the primordial singularity presented as the basis for physical space generation, based on the rationale of applying technical idea conforming to natural laws, it is possible to offer infinite scalability and potential as a property to the members.

### INDUSTRIAL APPLICABILITY

The present invention determining that an optimum means of increasing a real estate intrinsic value is activating air rights transactions of which active exercises of rights have been practically abandoned among private property, an explicit link with actual assets is presented as a means of overcoming a limit of virtual assets, the limit being incurred due to lack of links with the actual assets, and an air rights transaction market place is installed inside the metaverse platform and through intrinsic values of real estate and virtual property are all enhanced by a reciprocal technique sharing the virtual assets used in the metaverse platform as a payment means, thereby not only securing economic benefits by narrowing the gap between market value and intrinsic value, but also evaluating the ambiguous legal status of existing virtual assets as digital assets by expanding liquidity supply and enhancing credibility so that provides distinct utilitarian value in the industry.

What is claimed is:

1. A different space-linked metaverse platform system, wherein the metaverse platform system comprises a metaverse platform (1) comprising:
a three-dimensional (3D) virtual space;
a spherical metaverse planet (10) configured to allow setting of one or more radii (120) during a generation process; and
an air rights trading marketplace (30), wherein the spherical metaverse planet (10) is configured to:
(a) specify an initial center point for generating the 3D virtual space;
(b) identify the initial center point as a singularity (112) serving as a coordinate origin for a virtual universe;
(c) construct a spherical geometry of a 3D sphere by sequentially stacking a plurality of unit cubes (110) along X, Y, Z coordinate axes relative to the singularity (112) over a temporal dimension, each unit cube (110) having a defined side length (111);
(d) assign a unique address code to each of the unit cubes (110) according to a predefined coordinate system to enable precise location specification within the three-dimensional (3D) virtual space; and
(e) have a generation processor configured to perform a generation process including an instant displacement of an object within the metaverse platform (1) to a specific location based on the unique address code, (f) wherein the generation processor for the metaverse planet (10) is configured to allow setting of a limit altitude (130) and a limit depth (140) based on a setting of the metaverse platform.
